(19) United States
(12) Patent Application Publication
(10) Pub. No.: US 2025/0091025 A1
(43) Pub. Date: Mar. 20, 2025

(54) OPERATING A FEEDSTOCK REACTOR

(71) Applicant: EKONA POWER INC., Burnaby (CA)

(72) Inventors: Donald W. Kendrick, Bellevue, WA (US); Michael John Elsinga, Vancouver (CA)

(21) Appl. No.: 18/888,638

(22) Filed: Sep. 18, 2024

Related U.S. Application Data
(60) Provisional application No. 63/539,525, filed on Sep. 20, 2023.

(51) Int. Cl. B01J 6/00; B01J 19/24; C01B 3/24; F23C 6/04

(52) U.S. Cl. CPC B01J 6/008; B01J 19/2465; C01B 3/24; F23C 6/047; B01J 2219/00132; B01J 2219/00159; B01J 2219/00186; F23C 2201/20; F23C 2700/04

(57) ABSTRACT

A feedstock reactor having a reaction chamber connected to multiple combustors is operated such that, for each reaction cycle in a sequence of reaction cycles, one or more combustors of the multiple combustors are loaded with a combustible gas mixture, and/or the combustible gas mixture in a number of the multiple combustors is combusted, thereby producing combustion products that flow into the reaction chamber. For at least a first reaction cycle and a second reaction cycle in the sequence of reaction cycles, the second reaction cycle occurring after the first reaction cycle, the number of the combustors in which the combustible gas mixture is combusted is greater in the second reaction cycle than in the first reaction cycle, and/or an equivalence ratio of the combustible gas mixture loaded into the one or more combustors is higher in the second reaction cycle than in the first reaction cycle.

### CROSS-REFERENCE TO RELATED APPLICATION

This application claims priority from U.S. Provisional Patent Application Ser. No. 63/539,525 filed on Sep. 20, 2023, the entire disclosures of which are part of the disclosure of the present application and are hereby incorporated by reference in their entireties.

### FIELD

The present disclosure relates to thermal pyrolysis and in particular to methods and systems for operating a feedstock reactor.

### BACKGROUND

Thermal pyrolysis is a method by which a feedstock gas, such as a hydrocarbon, is decomposed without oxygen into its constituent elements (in the case of a hydrocarbon, carbon and hydrogen). The decomposition is triggered by sufficiently raising the temperature of the feedstock gas to a point at which the chemical bonds of the elements of the feedstock gas break down.

Such pyrolysis may be achieved, for example, by bringing the feedstock gas into thermal contact with a hot fluid. For instance, combustion product gases, formed as a result of combusting a combustible fuel, may be mixed with the feedstock gas. At high-enough temperatures, the mixing of the hot fluid with the feedstock gas, and the transfer of thermal energy from the hot fluid to the feedstock gas, is sufficient to cause the feedstock gas to break down and decompose.

When operating a feedstock reactor, it is important to mitigate the potential risk of thermal shock. For example, the reaction chamber is typically lined with refractory ceramics that are delicate and susceptible to cracking in response to thermal shock, which can compromise the heat retention of the reaction chamber.

### SUMMARY

According to a first aspect of the disclosure, there provided a method of operating a feedstock reactor comprising a reaction chamber connected to multiple combustors, wherein the method comprises: for each reaction cycle in a sequence of reaction cycles: loading one or more combustors of the multiple combustors with a combustible gas mixture; and combusting the combustible gas mixture in a number of the multiple combustors, thereby producing combustion products that flow into the reaction chamber, wherein, for at least a first reaction cycle and a second reaction cycle in the sequence of reaction cycles, the second reaction cycle occurring after the first reaction cycle, at least one of: the number of the combustors in which the combustible gas mixture is combusted is greater in the second reaction cycle than in the first reaction cycle; and an equivalence ratio of the combustible gas mixture loaded into the one or more combustors is higher in the second reaction cycle than in the first reaction cycle.

The method may further comprise loading the reaction chamber with a feedstock.

Loading the reaction chamber with the feedstock may comprise loading the reaction chamber with unreacted feedstock from the recycled reaction products of a previous reaction cycle.

For at least one reaction cycle, the produced combustion products that flow into the reaction chamber may mix with the feedstock and trigger decomposition of the feedstock into reaction products.

The method may further comprise extracting the reaction products from the reaction chamber and recycling at least a portion of the reaction products to the reaction chamber.

The number of the combustors in which the combustible gas mixture is combusted may be greater in the second reaction cycle than in the first reaction cycle.

The equivalence ratio of the combustible gas mixture loaded into the one or more combustors may be higher in the second reaction cycle than in the first reaction cycle.

Over multiple reaction cycles in the sequence of reaction cycles, the equivalence ratio of the combustible gas mixture loaded into the one or more combustors may be increased to a maximum after which the number of the combustors in which the combustible gas mixture is combusted may be increased.

The number of the combustors in which the combustible gas mixture is combusted may be increased by one.

After the number of the combustors in which the combustible gas mixture is combusted has been increased, the equivalence ratio of the combustible gas mixture loaded into a combustor added to the number of the combustors in which the combustible gas mixture is combusted may be set to a minimum.

The minimum may be an equivalence ratio from 0.4 to 0.6.

For each successive reaction cycle in the sequence of reaction cycles, the equivalence ratio of the combustible gas mixture loaded into the one or more combustors may be increased to a maximum, such as 1, after which the number of the combustors in which the combustible gas mixture is combusted may be increased.

The sequence of reaction cycles may be a second sequence of reaction cycles. For at least one reaction cycle in a first sequence of reaction cycles that precedes the second sequence of reaction cycles, loading the reaction chamber with the feedstock may comprise: pre-heating the feedstock; and loading the pre-heated feedstock into the reaction chamber.

Pre-heating the feedstock may comprise pre-heating the feedstock using an electric heater.

Loading the reaction chamber with the feedstock may comprise loading the reaction chamber with unreacted feedstock from recycled reaction products of a previous reaction cycle.

For each reaction cycle in the first sequence of reaction cycles, loading the reaction chamber with the feedstock may comprise: pre-heating the feedstock; and loading the pre-heated feedstock into the reaction chamber.

According to a further aspect of the disclosure, there is provided a system comprising: a feedstock reactor comprising a reaction chamber connected to multiple combustors; one or more controllers configured to control valving to: for each reaction cycle in a sequence of reaction cycles: load one or more combustors of the multiple combustors with a combustible gas mixture; and trigger a number of igniters to combust the combustible gas mixture in a number of the multiple combustors, thereby producing combustion products that flow into the reaction chamber, wherein, for at least a first reaction cycle and a second reaction cycle in the sequence of reaction cycles, the second reaction cycle occurring after the first reaction cycle, at least one of: the number of the combustors in which the combustible gas mixture is combusted is greater in the second reaction cycle than in the first reaction cycle; and an equivalence ratio of the combustible gas mixture loaded into the one or more combustors is higher in the second reaction cycle than in the first reaction cycle.

The one or more controllers may be further configured to control the valving to load the reaction chamber with a feedstock.

For at least one reaction cycle, the produced combustion products that flow into the reaction chamber may mix with the feedstock and trigger decomposition of the feedstock into reaction products.

The one or more controllers may be further configured to control the valving to extract the reaction products from the reaction chamber and recycle at least a portion of the reaction products to the reaction chamber.

The system may further comprise a heater for pre-heating the feedstock before the reaction chamber is loaded with the feedstock.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a feedstock reactor being operated, according to an embodiment of the disclosure;

FIG. 2 is a schematic diagram of a system for decomposing a feedstock, according to an embodiment of the disclosure;

FIG. 3A is a schematic diagram of a system for pre-heating a feedstock, according to an embodiment of the disclosure;

FIG. 3B is a plot of operating temperatures as a function of time, according to an embodiment of the disclosure; and

FIG. 4 is a flow diagram of a method of operating a feedstock reactor, according to an embodiment of the disclosure.

### DETAILED DESCRIPTION

The present disclosure seeks to provide novel methods and systems for operating a feedstock reactor. While various embodiments of the disclosure are described below, the disclosure is not limited to these embodiments, and variations of these embodiments may well fall within the scope of the disclosure which is to be limited only by the appended claims.

Generally, embodiments of the disclosure relate to methods and systems for performing pyrolysis of a feedstock gas, such as natural gas or a hydrocarbon gas, such as methane. Examples of such methods of pyrolysis, as well as example feedstock gas reactors that may be used for such pyrolysis, are described in further detail in Patent Cooperation Treaty (PCT) Publication No. WO 2020/118417, herein incorporated by reference in its entirety.

Generally, according to embodiments of the disclosure, a feedstock reactor comprises a reaction chamber connected to multiple combustors. The reactor is operated by loading the reaction chamber with feedstock. For each reaction cycle in a sequence of reaction cycles, one or more combustors of the multiple combustors are loaded with a combustible gas mixture. The combustible gas mixture in a number of the multiple combustors is combusted, thereby producing combustion products that flow into the reaction chamber, mix with the feedstock, and trigger decomposition of the feedstock into reaction products. The reaction products from the reaction chamber are extracted and at least a portion of the reaction products is recycled to the reaction chamber. For at least a first reaction cycle and a second reaction cycle in the sequence of reaction cycles, the second reaction cycle occurring after the first reaction cycle, the number of the combustors in which the combustible gas mixture is combusted is greater in the second reaction cycle than in the first reaction cycle, and/or a “richness” or equivalence ratio of the combustible gas mixture loaded into the one or more combustors is higher in the second reaction cycle than in the first reaction cycle.

Therefore, instead of using a maximally rich combustible gas mixture in each reaction cycle, and instead of operating the feedstock reactor by firing all combustors in each reaction cycle, the operating temperature of the feedstock reactor may be gradually increased by, over a number of consecutive reaction cycles, 1) gradually increasing the equivalence ratio of the combustible gas mixture that is loaded into the combustors, and/or by 2) gradually increasing the number of combustors that are fired. This approach may be particularly useful at start-up of the reactor, as it may allow the system to be carefully brought to thermal equilibrium and may minimize thermal shock on any ceramics or similar materials lining the reaction chamber, thereby preserving/prolonging their life.

For example: in a first reaction cycle, combustor 1 may be fired; in a subsequent second reaction cycle, combustors 1+2 may be fired; in a subsequent third reaction cycle, combustors 1+2+3 may be fired; and in a subsequent fourth reaction cycle, combustors 1+2+3+4 may be fired. This may yield a turndown in thermal capacity of 4:1. The first, second, third, and fourth reaction cycles may be consecutive or non-consecutive reaction cycles.

Furthermore, the combustors may operate at a variety of different equivalence ratios to provide increased turndown and finer control of the heat-up/ramp-up cycle. A methane-oxygen combustible gas mixture may easily yield a 3:1 turndown on equivalence ratio alone, and therefore an overall system turndown of 12:1 (assuming four combustors) may be achieved by sequentially increasing the number of combustors that are fired in addition to controlling the equivalence ratio of the combustible gas mixture. This may allow the temperatures of the gases and the system to increase more smoothly prior to achieving the feedstock temperature (e.g. about 1,000 K) that is required for pyrolysis to occur.

According to some embodiments, the feedstock reactor may be warmed up without introducing feedstock into the reaction chamber. However, introducing a small amount of feedstock into the reaction chamber may assist in warming up the reactor during each reaction cycle. The feedstock will start to decompose once it reaches a high-enough temperature (e.g., about 1,000 K). According to some embodiments, a Wobbe meter may be used to detect the start of the decomposition and in turn may operate a valve to begin extraction of reaction products from the reaction chamber.

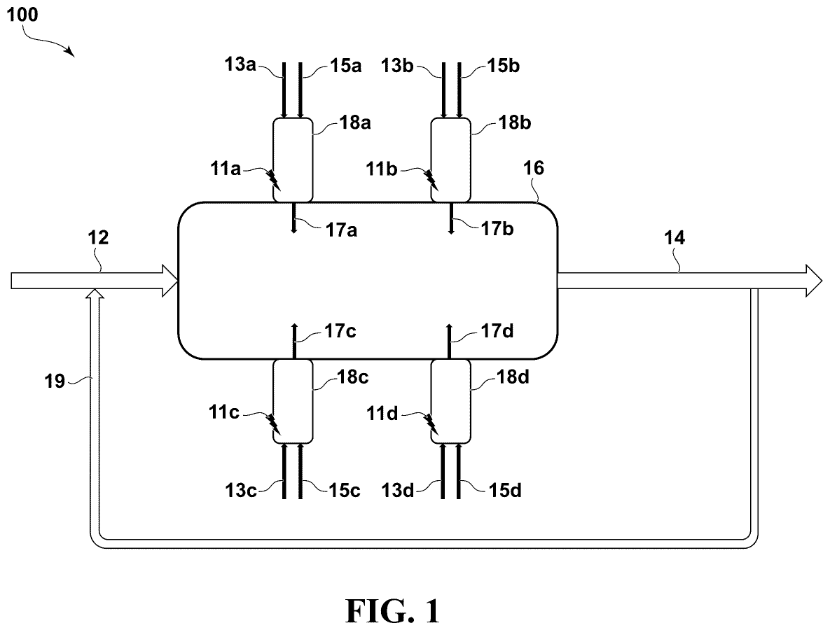

Turning to FIG. 1, there is shown an embodiment of a feedstock reactor 100 used to decompose feedstock.

Reactor 100 includes a reaction chamber 16 connected to multiple combustors 18a-18d (which collectively may be referred to as combustors 18). Each combustor 18 includes a combustion chamber into which is fed an oxidant 13a-13d (for example, pure oxygen or air) and a fuel 15a-15d (for example, unreacted feedstock). Each combustor 18 further includes an igniter 11a-11d for triggering combustion of the fuel and the oxidant within the combustion chamber.

During a first reaction cycle of reactor 100, a feedstock 12 (such as a hydrocarbon, for example methane) is fed under pressure into reaction chamber 16. At the same time, only one of combustors 18 (e.g., combustor 18a) is filled with a lean combustible gas mixture comprising a mixture of fuel 15a (e.g., methane or natural gas) and oxidant 13a (e.g., oxygen). For example, the equivalence ratio of the combustible gas mixture may be about 0.4. Once reaction chamber 16 and combustor 18a have been loaded with feedstock and combustible gas mixture, respectively, igniter 11a is triggered and causes combustion of the combustible gas mixture in combustor 18a which results in the generation of hot combustion products 17a. Combustion products flow 17a under pressure into reaction chamber 16. The injection of combustion products 17a results in mixing of combustion products 17a with the feedstock within reaction chamber 16.

As a result of the flow of combustion products 17a into reaction chamber 16, thermal energy is transferred from combustion products 17a to the feedstock. Energy is also transferred from combustion products 17a to the feedstock via dynamic compression of the feedstock as a result of the pressure increasing within reaction chamber 16 in response to the flow of hot, pressurized combustion products into reaction chamber 16. Past a certain point, the increase in the temperature of the feedstock is sufficient to drive decomposition or pyrolysis of the feedstock. In the case of methane, for example, the decomposition takes the following form:

CH₄+energy→C+2H₂

The pyrolysis reaction generates reaction products 14 (including, for example, CH₄, H₂, H₂O, CO, CO₂, and O₂) that are extracted from reaction chamber 16. A portion of reaction products 14 is recycled back to reaction chamber 16. The recycled reaction products 19 include some unreacted feedstock whose temperature has been increased as a result of the pyrolysis reaction undergone in the first reaction cycle.

The process is then repeated in a second, subsequent reaction cycle. In particular, the recycled, unreacted feedstock 19, together with some fresh feedstock 12, is loaded into reaction chamber 16. In this reaction cycle, only combustor 18a is loaded with the combustible gas mixture. However, the equivalence ratio of the combustible gas mixture that is used is increased, and for example may be set to about 0.7. The process then continues as in the first reaction cycle, i.e., once reaction chamber 16 and combustor 18a have been loaded with feedstock and combustible gas mixture, respectively, igniter 11a is triggered and causes combustion of the combustible gas mixture in combustor 18a which results in the generation of hot combustion products 17a. Combustion products 17a flow under pressure into reaction chamber 16. The injection of combustion products 17a results in mixing of combustion products 17a with the feedstock within reaction chamber 16. Reaction products 14 are then extracted from reaction chamber 16, and a portion of reaction products 14 is recycled to reaction chamber 16 together with fresh feedstock 12. The recycled reaction products 19 include some unreacted feedstock whose temperature has been increased as a result of the pyrolysis reaction undergone in the second reaction cycle.

In a third, subsequent reaction cycle, only combustor 18a is loaded with combustible gas mixture. However, the equivalence ratio of the combustible gas mixture is increased yet again, and this time to about 1.0. The pyrolysis process then proceeds as described above.

Once the equivalence ratio of the combustible gas mixture has been increased to a maximum (e.g., 1.0) for combustor 18a, in the subsequent reaction cycle, an additional combustor (e.g., combustor 18b) is loaded with combustible gas mixture. This newly-added combustor is loaded with a relatively lean combustible gas mixture, such as a mixture having an equivalence ratio of about 0.4. Once reaction chamber 16 and combustors 18a and 18b have been loaded with feedstock and combustible gas mixture, respectively, igniters 11a and 11b are triggered and cause combustion of the combustible gas mixture in combustors 18a and 18b which results in the generation of hot combustion products 17a and 17b. Combustion products 17a and 17b flow under pressure into reaction chamber 16, mix with the feedstock, and trigger decomposition of the feedstock. Reaction products 14 are then extracted from reaction chamber 16, and a portion of reaction products 14 is recycled to reaction chamber 16 together with fresh feedstock. The recycled reaction products 19 include some unreacted feedstock whose temperature has been increased as a result of the pyrolysis reaction undergone in the reaction cycle.

In the next reaction cycle, only combustors 18a and 18b are loaded with combustible gas mixture, but the equivalence ratio of the combustible gas mixture that is used to load combustor 18b is increased (for example, to about 0.7). The pyrolysis process then proceeds as described above.

In the next reaction cycle, only combustors 18a and 18b are loaded with combustible gas mixture, but the equivalence ratio of the combustible gas mixture that is used to load combustor 18b is increased (for example, to about 1.0). The pyrolysis process then proceeds as described above.

In the next reaction cycle, since the equivalence ratio of the combustible gas mixture has already been increased to a maximum for both combustors 18a and 18b, an additional combustor (e.g. combustor 18c) is used to further increase the temperature of the feedstock that is eventually recycled to reaction chamber 16. Combustor 18c is loaded with a relatively lean combustible gas mixture, such as a mixture having an equivalence ratio of about 0.4. Once reaction chamber 16 and combustors 18a, 18b, and 18c have been loaded with feedstock and combustible gas mixture, respectively, igniters 11a, 11b, and 11c are triggered and cause combustion of the combustible gas mixture in combustors 18a, 18b, and 18c which results in the generation of hot combustion products 17a, 17b, and 17c. Combustion products 17a, 17b, and 17c flow under pressure into reaction chamber 16, mix with the feedstock, and trigger decomposition of the feedstock. Reaction products 14 are then extracted from reaction chamber 16, and a portion of reaction products 14 is recycled to reaction chamber 16 together with fresh feedstock. The recycled reaction products 19 include some unreacted feedstock whose temperature has been increased as a result of the pyrolysis reaction undergone in the reaction cycle.

In the next reaction cycle, only combustors 18a, 18b, and 18c are loaded with combustible gas mixture, but the equivalence ratio of the combustible gas mixture that is used to load combustor 18c is increased (for example, to about 0.7). The pyrolysis process then proceeds as described above.

In the next reaction cycle, only combustors 18a, 18b, and 18c are loaded with combustible gas mixture, but the equivalence ratio of the combustible gas mixture that is used to load combustor 18c is increased (for example, to about 1.0). The pyrolysis process then proceeds as described above.

In the next reaction cycle, since the equivalence ratio of the combustible gas mixture has already been increased to a maximum for combustors 18a, 18b, and 18c, the final combustor (i.e., combustor 18d) is used to further increase the temperature of the feedstock that is eventually recycled to reaction chamber 16. Combustor 18d is loaded with a relatively lean combustible gas mixture, such as a mixture having an equivalence ratio of about 0.4. Once reaction chamber 16 and combustors 18a, 18b, 18c, and 18d have been loaded with feedstock and combustible gas mixture, respectively, igniters 11a, 11b, 11c, and 11d are triggered and cause combustion of the combustible gas mixture in combustors 18a, 18b, 18c, and 18d which results in the generation of hot combustion products 17a, 17b, 17c, and 17d. Combustion products 17a, 17b, 17c, and 17d flow under pressure into reaction chamber 16, mix with the feedstock, and trigger decomposition of the feedstock. Reaction products 14 are then extracted from reaction chamber 16, and a portion of reaction products 14 is recycled to reaction chamber 16 together with fresh feedstock. The recycled reaction products 19 include some unreacted feedstock whose temperature has been increased as a result of the pyrolysis reaction undergone in the reaction cycle.

In the next subsequent reaction cycle, the equivalence ratio of the combustible gas mixture that is used to load combustor 18d is increased (for example, to about 0.7). The pyrolysis process then proceeds as described above.

In the subsequent reaction cycle, the equivalence ratio of the combustible gas mixture that is used to load combustor 18d is increased (for example, to about 1.0). The pyrolysis process then proceeds as described above.

For all subsequent reaction cycles, all combustors 18 are fired using a maximally-rich combustible gas mixture (i.e., having an equivalence ration of about 1.0).

As can be seen, as operation of feedstock reactor 100 progresses, the equivalence ratio of the combustible gas mixture that is loaded into a given combustor gradually increases to a maximum before additional combustors are used to contribute to the overall pyrolysis reaction in subsequent reaction cycles.

It shall be recognized that the above-indicated equivalence ratios of 0.4, 0.7, and 1.0 are used as examples only, and according to some embodiments the equivalence ratio of the combustible gas mixture may be increased more or less gradually. For example, the equivalence ratio may be increased to achieve incremental increases of about 0.1 every reaction cycle, or about 0.25 every reaction cycle.

According to some embodiments, more than one additional combustor may be fired once the equivalence ratio of the combustible gas mixture has reached a maximum. For instance, with a reactor having 10 combustors in total, after the equivalence ratio for combustor 1 has been increased to a maximum, in the next reaction cycle combustors 2-4 may be fired in addition to combustor 1. Once the equivalence ratio for combustors 2-4 has been increased to a maximum, in the next reaction cycle combustors 5-7 may be fired in addition to combustor 1-4. Lastly, once the equivalence ratio for combustors 5-7 has been increased to a maximum, in the next reaction cycle combustors 8-10 may be fired in addition to combustor 1-7.

According to still further embodiments, instead of increasing the equivalence ratio of the combustible gas mixture before firing additional combustors, the reverse may take place: i.e., additional combustors may be fired until all combustors are being fired every reaction cycle, before the equivalence ratio of the combustible gas mixture provided to each combustor is increased. According to still further embodiments: the equivalence ratio of the combustible gas mixture provided to a combustor may first be increased to a value below a maximum value; then, in the next reaction cycle, an additional combustor may be fired; and then, in the next reaction cycle, the equivalence ratio of the combustible gas mixture provided to the initial combustor may be further increased.

As can be seen, there exist many different strategies for incrementally increasing the temperatures of the feedstock and the reactor each successive reaction cycle, all of which are embraced by the current disclosure.

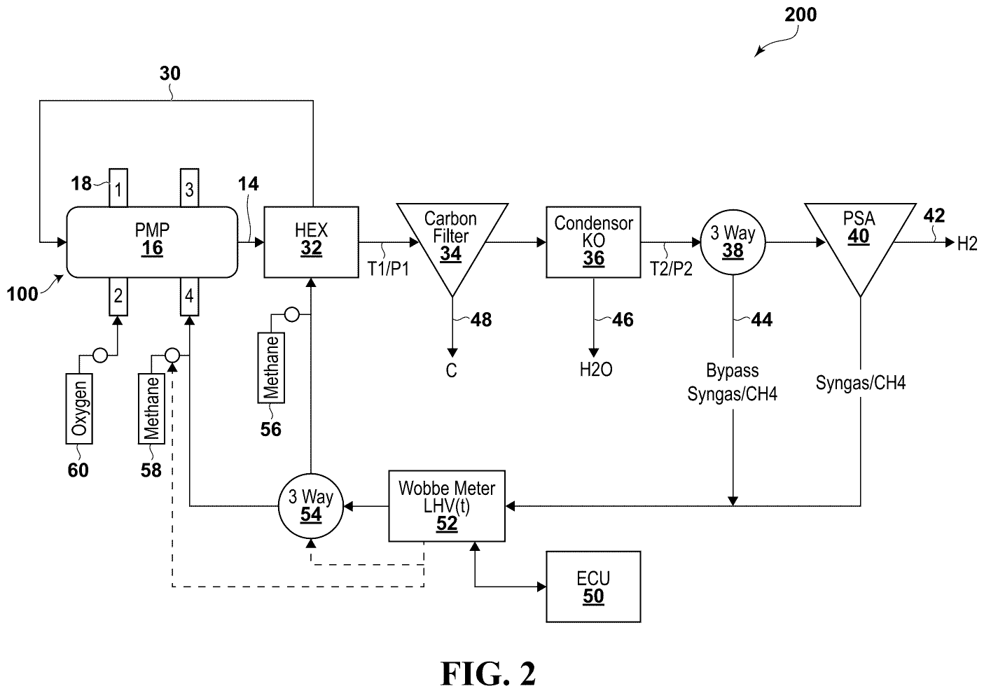

Turning to FIG. 2, there is shown a system 200 for operating a feedstock reactor 100, according to an embodiment of the disclosure.

System 200 includes reactor 100 with reaction chamber 16 connected to combustors 18, as described in detail above in connection with FIG. 1. A supply of oxygen 60 is used to provide oxidant to combustors 18 (for clarity, in FIG. 2, only combustor 2 is shown connected to oxygen supply 60), and a supply of methane 58 is used to provide fuel to combustors 18 (for clarity, in FIG. 2, only combustor 4 is shown connected to methane supply 58).

Reaction products 14 extracted from reaction chamber 16 are directed to a heat exchanger 32. Heat exchanger 32 enables heat recuperation and therefore reduces the required size of the combustors, increasing the overall efficiency of each reaction cycle. Another supply of methane 56 is connected to heat exchanger 32. One output of heat exchanger 32 is passed to a carbon filter 34 that filter carbon 48 out of the stream of reaction products 14. The other output 30 of heat exchanger 32 is connected to reaction chamber 16 for allowing fresh feedstock, pre-heated by heat exchanger 32, to be loaded into reaction chamber 16.

The output of carbon filter 34 is then passed to a condenser water knockout drum 36 that extracts water 46 from the stream of remaining reaction products. The output of condenser water knockout drum 36 is passed to a three-way valve 38 that extracts some syngas/methane 44 from the stream of remaining reaction products. Another output of three-way valve 38 is passed to a pressure swing adsorption (PSA) device 40 that extracts hydrogen (H₂) 42 from the stream of remaining reaction products. The remaining reaction products (including syngas/methane output from PSA device 40 and syngas/methane 44 output from three-way valve 38) are returned to a Wobbe meter 52 for calculating the lower heating value of the fuel. An electronic control unit (ECU) 50, such as a computer processor or other circuitry, is used to control the operation of Wobbe meter 52 and, in particular, may trigger extraction of reaction products 14 from reaction chamber 16 once Wobbe meter 52 detects that pyrolysis is occurring. Wobbe meter 52 is connected to another three-way valve 54 that is in turn connected to heat exchanger 32 and combustors 18 (for clarity, in FIG. 2, only combustor 4 is shown connected to three-way valve 54). Wobbe meter 52 is further connected to methane supply 58. As described above, Wobbe meter 58 determines the lower heating value of the fuel. Based on the lower heating value, three-way valve 54 will send the appropriate fuel to combustors 18 (using methane supply 58) or reaction chamber 16 (using methane supply 56).

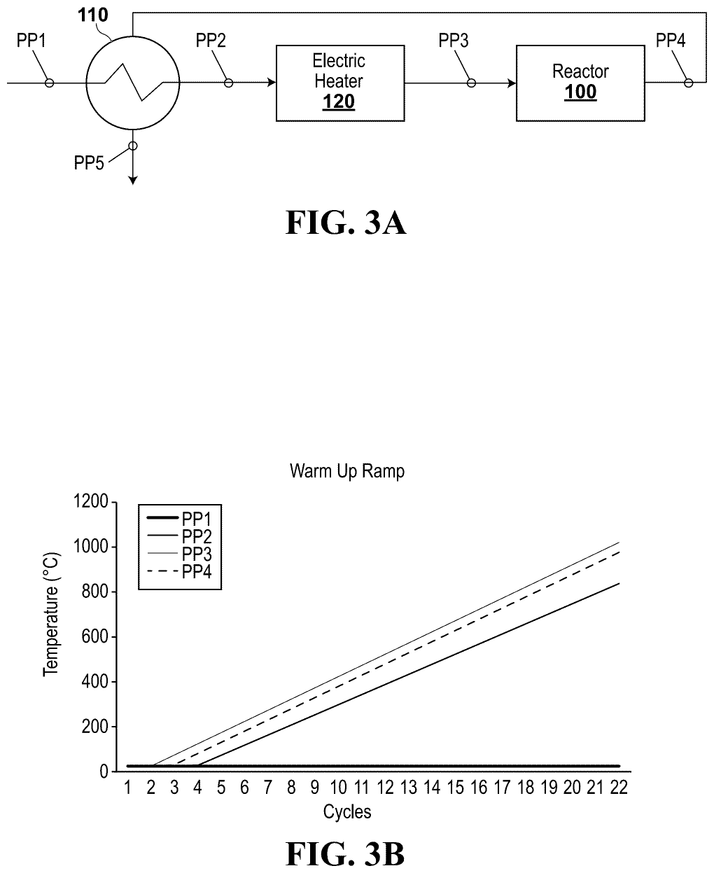

Turning now to FIGS. 3A and 3B, before gradually increasing the equivalence ratio of the combustible gas mixture, and the number of combustors that are fired every reaction cycle, one or more heating sources may be used to pre-heat the feedstock before it enters reaction chamber 16. For example, as can be seen in FIG. 3A, an electric heater 120 may be positioned between a feedstock/syngas heat exchanger 110 (which may be heat exchanger 32 in FIG. 2) and feedstock reactor 100, and may be used to pre-heat the feedstock over a certain number of reaction cycles. The temperature (PP3) of the feedstock that enters reactor 100 is therefore gradually increased every reaction cycle by electric heater 120, as can be seen by the plot in FIG. 3B.

According to some embodiments, a heater (such as electric heater 120) is employed to pre-heat the feedstock every reaction cycle until a certain minimum feedstock temperature (for example, about 1,000 K) is achieved. Once this minimum temperature is attained, the equivalence ratio of the combustible gas mixture, and the number of combustors that are fired every reaction cycle, are increased as described above in connection with FIG. 1.

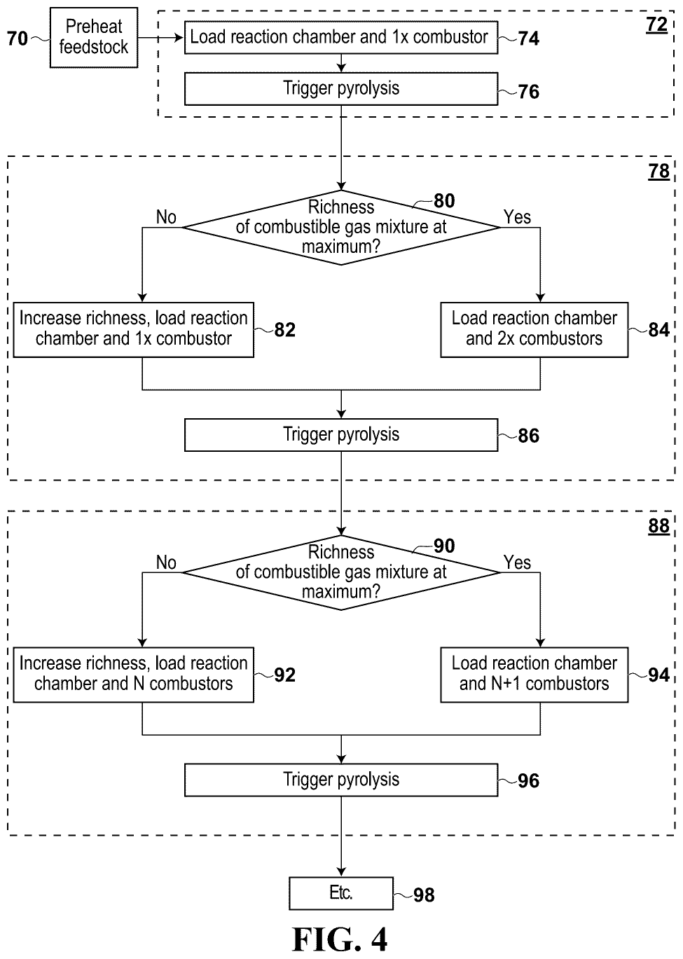

Turning to FIG. 4, there is shown a flow diagram of a method of operating a feedstock reactor, according to an embodiment of the disclosure.

At block 70, a source of feedstock is pre-heated. For example, an electric heater may be used to pre-heat the feedstock, as described above in connection with FIGS. 3A and 3B. According to some embodiments, the feedstock may be pre-heated to at least about 1,000 K.

After pre-heating the feedstock, in a first reaction cycle 72, at block 74, the reaction chamber is loaded with the pre-heated feedstock and one combustor is loaded with a mixture of fuel and oxidant at a certain, predetermined equivalence ratio (for example, about 0.4). At block 76, the combustible mixture is caused to combust, and the combustion products mix with the feedstock and trigger decomposition of the feedstock. A portion of the reaction products generated as a result of the pyrolysis is recycled to the reaction chamber.

In a second reaction cycle 78, at block 80, the equivalence ratio of the combustible gas mixture combusted in the first reaction cycle is compared (for example, using a computer controller) to a maximum equivalence ratio (which may be, for example, about 1.0). If the equivalence ratio is not yet at the maximum, then the equivalence ratio of the combustible gas mixture is increased, the reaction chamber is loaded with fresh feedstock (as well as the recycled, unreacted feedstock from the previous reaction cycle), and the same combustor is loaded with the mixture of fuel and oxidant at the high equivalence ratio. At block 86, the combustible mixture is caused to combust, and the combustion products mix with the feedstock and trigger decomposition of the feedstock. A portion of the reaction products generated as a result of the pyrolysis is recycled to the reaction chamber.

On the other hand, if the equivalence ratio of the combustible gas mixture combusted in the first reaction cycle is already at a maximum, then, at block 84, the reaction chamber is loaded with fresh feedstock (as well as the recycled, unreacted feedstock from the previous reaction cycle), and two combustors (including the combustor from the first reaction cycle 72) are loaded with the mixture of fuel and oxidant. At block 86, the combustible mixture is caused to combust, and the combustion products mix with the feedstock and trigger decomposition of the feedstock. A portion of the reaction products generated as a result of the pyrolysis is recycled to the reaction chamber.

More generally, in a further reaction cycle 88, at block 90, the equivalence ratio of the combustible gas mixture combusted in the previous reaction cycle is compared (for example, using a computer controller) to a maximum equivalence ratio (which may be, for example, about 1.0). If the equivalence ratio is not yet at the maximum, then the equivalence ratio of the combustible gas mixture is increased, the reaction chamber is loaded with fresh feedstock (as well as the recycled, unreacted feedstock from the previous reaction cycle) and the same N combustors as fired in the previous reaction cycle are loaded with the mixture of fuel and oxidant at the increased equivalence ratio. At block 92, the combustible mixture is caused to combust, and the combustion products mix with the feedstock and trigger decomposition of the feedstock. A portion of the reaction products generated as a result of the pyrolysis is recycled to the reaction chamber.

On the other hand, if the equivalence ratio of the combustible gas mixture combusted in the previous reaction cycle is already at a maximum, then, at block 94, the reaction chamber is loaded with fresh feedstock (as well as the recycled, unreacted feedstock from the previous reaction cycle), and N+1 combustors (including the N combustors from the previous reaction cycle) are loaded with the mixture of fuel and oxidant. At block 96, the combustible mixture is caused to combust, and the combustion products mix with the feedstock and trigger decomposition of the feedstock. A portion of the reaction products generated as a result of the pyrolysis is recycled to the reaction chamber.

The process may repeat until all combustors are being triggered with a combustible gas mixture at a maximum equivalence ratio (block 98).

Throughout the embodiments described herein, operation of the reactor's various valves may be controlled by a suitable controller (such as a microprocessor) comprising circuitry. The controller (not shown), or some other controller, may control the loading and unloading of the reaction chamber by controlling valves and compressors or similar devices, for example. The controller may also control the injection of the fuel and oxidant into the combustors.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of operating a feedstock reactor comprising a reaction chamber connected to multiple combustors, wherein the method comprises:
for each reaction cycle in a sequence of reaction cycles:
loading one or more combustors of the multiple combustors with a combustible gas mixture; and
combusting the combustible gas mixture in a number of the multiple combustors, thereby producing combustion products that flow into the reaction chamber,
wherein, for at least a first reaction cycle and a second reaction cycle in the sequence of reaction cycles, the second reaction cycle occurring after the first reaction cycle, at least one of:
the number of the combustors in which the combustible gas mixture is combusted is greater in the second reaction cycle than in the first reaction cycle; and
an equivalence ratio of the combustible gas mixture loaded into the one or more combustors is higher in the second reaction cycle than in the first reaction cycle.

2. The method of claim 1, further comprising loading the reaction chamber with a feedstock.

3. The method of claim 2, wherein, for at least one reaction cycle, the produced combustion products that flow into the reaction chamber mix with the feedstock and trigger decomposition of the feedstock into reaction products.

4. The method of claim 3, further comprising extracting the reaction products from the reaction chamber and recycling at least a portion of the reaction products to the reaction chamber.

5. The method of claim 1, wherein the number of the combustors in which the combustible gas mixture is combusted is greater in the second reaction cycle than in the first reaction cycle.

6. The method of claim 1, wherein the equivalence ratio of the combustible gas mixture loaded into the one or more combustors is higher in the second reaction cycle than in the first reaction cycle.

7. The method of claim 1, wherein, over multiple reaction cycles in the sequence of reaction cycles, the equivalence ratio of the combustible gas mixture loaded into the one or more combustors is increased to a maximum after which the number of the combustors in which the combustible gas mixture is combusted is increased.

8. The method of claim 1, wherein, after the number of the combustors in which the combustible gas mixture is combusted has been increased, the equivalence ratio of the combustible gas mixture loaded into a combustor added to the number of the combustors in which the combustible gas mixture is combusted is set to a minimum.

9. The method of claim 8, wherein the minimum is an equivalence ratio from 0.4 to 0.6.

10. The method of claim 1, wherein, for each successive reaction cycle in the sequence of reaction cycles, the equivalence ratio of the combustible gas mixture loaded into the one or more combustors is increased to a maximum after which the number of the combustors in which the combustible gas mixture is combusted is increased.

11. The method of claim 10, wherein, after the number of the combustors in which the combustible gas mixture is combusted is increased, the equivalence ratio of the combustible gas mixture loaded into a combustor added to the number of the combustors in which the combustible gas mixture is combusted is set to a minimum.

12. The method of claim 11, wherein the minimum is an equivalence ratio from 0.4 to 0.6.

13. The method of claim 2, wherein the sequence of reaction cycles is a second sequence of reaction cycles, and wherein, for at least one reaction cycle in a first sequence of reaction cycles that precedes the second sequence of reaction cycles, loading the reaction chamber with the feedstock comprises:
pre-heating the feedstock; and
loading the pre-heated feedstock into the reaction chamber.

14. The method of claim 13, wherein pre-heating the feedstock comprises pre-heating the feedstock using an electric heater.

15. The method of claim 13, wherein loading the reaction chamber with the feedstock comprises loading the reaction chamber with unreacted feedstock from recycled reaction products of a previous reaction cycle.

16. The method of claim 13, wherein, for each reaction cycle in the first sequence of reaction cycles, loading the reaction chamber with the feedstock comprises:
pre-heating the feedstock; and
loading the pre-heated feedstock into the reaction chamber.

17. A system comprising:
a feedstock reactor comprising a reaction chamber connected to multiple combustors;
one or more controllers configured to control valving to:
for each reaction cycle in a sequence of reaction cycles:
load one or more combustors of the multiple combustors with a combustible gas mixture; and
trigger a number of igniters to combust the combustible gas mixture in a number of the multiple combustors, thereby producing combustion products that flow into the reaction chamber,
wherein, for at least a first reaction cycle and a second reaction cycle in the sequence of reaction cycles, the second reaction cycle occurring after the first reaction cycle, at least one of:
the number of the combustors in which the combustible gas mixture is combusted is greater in the second reaction cycle than in the first reaction cycle; and
an equivalence ratio of the combustible gas mixture loaded into the one or more combustors is higher in the second reaction cycle than in the first reaction cycle.

18. The system of claim 17, wherein the one or more controllers are further configured to control the valving to load the reaction chamber with a feedstock.

19. The system of claim 18, wherein, for at least one reaction cycle, the produced combustion products that flow into the reaction chamber mix with the feedstock and trigger decomposition of the feedstock into reaction products.

20. The system of claim 18, further comprising a heater for pre-heating the feedstock before the reaction chamber is loaded with the feedstock.
